(19) United States
(12) Patent Application Publication
(10) Pub. No.: US 2017/0213624 A1
(43) Pub. Date: Jul. 27, 2017

(54) MAGNETIC MATERIAL LOADED WITH MAGNETIC ALLOY PARTICLES AND METHOD FOR PRODUCING SAID MAGNETIC MATERIAL

(71) Applicants: TANAKA KIKINZOKU KOGYO K.K., Tokyo (JP); The University of Tokyo, Tokyo (JP)

(72) Inventors: Shin-ichi OHKOSHI, Tokyo (JP); Asuka NAMAI, Tokyo (JP); Marie YOSHIKIYO, Tokyo (JP); Kenji TANAKA, Tokyo (JP); Tomomichi NASU, Tokyo (JP); Yasuto MIYAMOTO, Tokyo (JP); Takuma TAKEDA, Tokyo (JP); Kenta MATSUMOTO, Tokyo (JP); Yasushi MASAHIRO, Tokyo (JP); Junichi TANIUCHI, Ibaraki (JP)

(21) Appl. No.: 15/324,353

(22) PCT Filed: Jul. 8, 2015
(86) PCT No.: PCT/JP2015/069692

§ 371 Date: Jan. 6, 2017

(30) Foreign Application Priority Data
Jul. 17, 2014 (JP) 2014-146773
Jan. 6, 2015 (JP) 2015-000762

(51) Int. Cl. H01F 1/03; B22F 1/00; B22F 9/30; C22C 5/04; G11B 5/65; C22C 38/00; C22F 1/14; C22F 1/10; C21D 9/00; C21D 6/00; B22F 1/02; C22C 19/07

(52) U.S. Cl. CPC H01F 1/0306; B22F 1/02; B22F 1/0018; B22F 9/30; C22C 5/04; C22C 19/07; C22C 38/00; C22F 1/14; C22F 1/10; C21D 9/0068; C21D 6/00; G11B 5/653; G11B 5/656; B22F 2301/15; B22F 2301/35; B22F 2301/25; B22F 2302/45; B22F 2998/10; B22F 2304/054; C03C 15/00

(57) ABSTRACT

The present invention relates to a magnetic material containing a magnetic alloy particle having an ordered crystal structure. The magnetic material according to the present invention is the one composed of a magnetic alloy particle having crystal magnetic anisotropy and being composed of an FePt alloy, a CoPt alloy, an FePd alloy, a Co₃Pt alloy, an Fe₃Pt alloy, a CoPt₃ alloy, an FePt₃ alloy, or the like, and a silica carrier covering the magnetic alloy, in which the silica carrier contains an alkali-earth metal compound such as an oxide, hydroxide or silicate compound of Ba, Ca, or Sr. The magnetic material according to the present invention is excellent in magnetic properties such as coercive force.

### TECHNICAL FIELD

The present invention relates to a magnetic material containing a magnetic alloy particle such as an FePt alloy or a CoPt alloy. Particularly, it relates to a magnetic material having a magnetic alloy particle capable of exerting high coercive force though it has a minute size of nano order, and to a manufacturing method of the material.

### BACKGROUND ART

Along with the progress of IT technologies in recent years, it is required for magnetic recording media for computers and the like to be capable of recording more information with space-saving and high density. In a magnetic recording medium for a magnetic disk device and the like, it becomes necessary to make minute a recording unit of a recording layer in order to improve recording density. The recording unit in a magnetic recording medium is equal to a crystal grain diameter of a magnetic material constituting the recording layer, and, therefore, it has been said that it is effective to make minute a diameter of a crystal grain having large crystal magnetic anisotropy for improving the recording density. Accordingly, to this end, microparticulation of magnetic powder has been progressed.

However, from recent examinations, it is indicated that there is a limit in improvement of the recording density by the microparticulation of magnetic powder. This is because, although it is possible to improve the recording density by progressing microparticulation of magnetic powder, there is such a problem as deterioration of resistance properties for thermal fluctuation and generation of instability of magnetization. A recording medium with instability of magnetization cannot achieve the original use application, because information once magnetized (recorded) may disappear.

Therefore, in recent examinations, it is regarded as promising to apply alloy powder composed of an FePt alloy or the like that has high crystal magnetic anisotropy and can exert high ferromagnetism having high coercive force as a constituent material of magnetic powder, although microparticulation of magnetic powder is progressed. Here, magnetic properties of an FePt alloy etc. differ depending on the crystal structure of the alloy, and it is said that the alloy having an fct (face-centered orthorhombic) structure in which Fe and Pt are arranged regularly in layers has higher crystal magnetic anisotropy and higher coercive force than the alloy having an fcc (face-centered cubic) structure in which arrangement of Fe and Pt in the crystal lattice is random.

Regarding magnetic alloys such as an FePt alloy, there are already some examination examples for particles having particle diameters of nano order with an ordered structure and a method for manufacturing such particles. For example, in PTL 1, FePt nanoparticles manufactured by a reducing method and annealing treatment are described. In the manufacturing process of the FePt nanoparticles, metal Fe is reduction-precipitated on a Pt nuclear particle generated from a Pt compound and a reducing agent, which is further aged at a prescribed temperature and Pt and Fe are made into an alloy. Further, magnetic particles of an fct structure are obtained by the annealing treatment of FePt alloy particles at 400° C. or higher.

Furthermore, in PTL 2, there is disclosed regular alloy phase nanoparticles, obtained by previously manufacturing nanoparticles of an FePt alloy etc., covering the nanoparticles with a membrane composed of a metal oxide such as silica (SiO₂), and subjecting the covered particles to a high temperature heat treatment to regularize the crystal structure.

### CITATION LIST

### Patent Literature

PTL 1: Japanese Patent No. 5136751

PTL 2: International Publication Pamphlet No. 2006/070572

### SUMMARY OF INVENTION

### Technical Problem

Conventional ordered magnetic alloy particles contain roughly an ordered phase, and exert a certain level of magnetic properties, but are not exactly suitable. As grasped from above-described background arts, a heat treatment of the generated alloy at high temperatures is required for ordering the crystal structure of the alloy. In the case of FePt nanoparticles described in PTL 1, the FePt alloy is directly heat-treated in manufacturing, but there is such a risk that, in the heat treatment, alloy particles aggregate and form coarse particles, and one not preferable from the viewpoint of particle diameter control is manufactured.

In contrast, magnetic alloy particles described in PTL 2 do not bring about a problem of aggregation of alloy particles caused by heat treatment by covering alloy particles before ordering. However, the present inventors have confirmed from examinations that alloy particles manufactured according to the literature have insufficient ordering of a crystal structure, and that there are a room for improvement from the viewpoint of magnetic properties.

Consequently, the present invention aims at providing a magnetic material containing magnetic alloy particles having an ordered crystal structure such as an FePt alloy, the material having suitable magnetic properties such as high coercive force, and a manufacturing method of the material.

### Solution to Problem

When magnetic alloy particles having an ordered crystal structure are to be manufactured/utilized, it is considered that it is suitable to apply a carrier for supporting or protecting an alloy particle such as a silica membrane in the PTL 2, and that it is preferable to utilize a form of combination of the carrier and the magnetic alloy particle as a magnetic material. This is because a heat treatment is indispensable for ordering in a manufacturing process of magnetic alloy particles, but increase in the particle diameter caused by aggregation of alloy particles due to the heating must be avoided, and, to this end, the use of a silica carrier is preferable. Although a carrier is a constituent unnecessary for manufacturing a magnetic recording medium etc., separation of a magnetic alloy particle from the carrier is sufficiently possible, and the carrier is considered to be rather useful when it is considered as the carrier of the magnetic alloy particle.

Therefore, present inventors, after having examined a technique for manufacturing a magnetic alloy particle having suitably ordered crystal structure while utilizing silica as a carrier, found a magnetic alloy particle capable of exerting more preferable magnetic properties caused by acceleration of ordering than conventional ones, by causing a silica carrier to contain an alkali-earth metal compound such as Ba and performing generation (reduction) and ordering of a magnetic alloy at the same timing, and conceived the present invention.

That is, the present invention is a magnetic material composed of a magnetic alloy particle having crystal magnetic anisotropy and a silica carrier covering the magnetic alloy particle, in which the silica carrier contains an alkali-earth metal compound.

Hereinafter, the present invention will be described in detail. The magnetic material according to the present invention is composed of a magnetic alloy particle and a silica carrier covering the particle, and has, in a concrete constitution, a form of a core-shell type composite material having a magnetic alloy particle as a core and a silica carrier covering at least a part of the particle.

A preferable constituent material of the magnetic alloy particle includes alloys composed of a ferromagnetic metal and a precious metal such as an FePt alloy, a CoPt alloy, an FePd alloy, a Co₃Pt alloy, an Fe₃Pt alloy, a CoPt₃ alloy, and an FePt₃ alloy. These alloys are magnetic alloys that exert crystal magnetic anisotropy and have high coercive force, by ordering the crystal structure.

Regarding these magnetic alloy particles, a composition ratio (based on atom % (at %)) of a ferromagnetic metal (M) and a precious metal (PM) is, in the case of an FePt alloy, a CoPt alloy and an FePd alloy, preferably M:PM=50:50±10 at %, more preferably ±5 at %. Moreover, in the case of a Co₃Pt alloy and an Fe₃Pt alloy, preferably M:PM=75:25±10 at %, more preferably ±5 at %. Further, in the case of a CoPt₃ alloy and an FePt₃ alloy, preferably M:PM=25:75±10 at %, more preferably ±5 at %. Meanwhile, as a calculation method of the composition ratio (M:PM) of a ferromagnetic metal and a precious metal, for example, the ratio can be calculated based on a composition ratio measured from elemental analysis by an inductively-coupled plasma mass spectrometer (ICP-MS) and X-ray fluorescence analysis (XRF). However, the composition ratio measured by these analytical methods is a composition ratio of both metals including impurities. Consequently, an accurate composition ratio can be calculated by adding a weight ratio of magnetic alloy particles and impurities obtained by refinement in Rietveld refinement of an X-ray diffraction (XRD) pattern to the composition ratio.

Further, regarding a structure of above-described magnetic alloys, an FePt alloy, a CoPt alloy and an FePd alloy form an L1₀ structure, a Co₃Pt alloy and an Fe₃Pt alloy form an ordered structure such as an L1₂ structure, a DO₁₉ structure or a Pmm2 structure, and a CoPt₃ alloy and an FePt₃ alloy form an L1₂ structure (see FIG. 1). These magnetic alloys preferably are of a highly ordered fct structure, fcc structure, or hcp structure.

Meanwhile, particle diameters of magnetic alloy particles lie preferably in a range of not less than 1 nm and not more than 100 nm, and lie more preferably in a range of not less than 1 nm and not more than 20 nm. This is because it is desired to have minute particle diameters when utilized as magnetic particles.

The silica carrier that covers an above-described magnetic alloy particle is utilized for making formation and structure ordering of a magnetic alloy particle into an appropriate state in a manufacturing process of the magnetic material according to the present invention. Regarding an amount of the silica carrier, preferable one lies in a range of not less than 0.5 and not more than 20, in terms of a ratio of a molar number of Si contained in a silica carrier and a total molar number of metals constituting a magnetic alloy particle (for example, in the case of an FePt alloy, it is the sum of the molar number of Fe and the molar number of Pt) (Si/magnetic alloy particle). This is because when the ratio is less than 0.5, magnetic alloy particles may aggregate and generate coarse particles, and, even if the silica carrier is used more than 20, particle diameters do not change remarkably, which is not preferable economically.

Meanwhile, the silica carrier covers wholly or partially the surface of a magnetic alloy particle, and a film thickness of the silica at this time is preferably not less than 1 nm and not more than 100 nm, more preferably not less than 1 nm and not more than 30 nm. The silica having such a thickness works as a partition wall having a thickness sufficient to prevent mutual aggregation of magnetic alloy particles. Further, magnetic recording media of bit patterned media (BPM) that allow ultrahigh-density recording have a structure in which nanometer scale ferromagnetic bodies of a partitioned with walls of a non-magnetic material are arranged regularly on a substrate, and silica of such a thickness works as a partition wall of a thickness sufficient to form magnetically isolated ferromagnetic bodies. The magnetic material constituted by covering a magnetic alloy particle with the silica carrier is a particulate material having a particle diameter of not less than 0.1 μm and not more than 100 μm.

Further, the silica carrier in the present invention has a characteristic in containing an alkali-earth metal compound. It is possible to form particles which have suitable magnetic properties and in which ordering of magnetic alloy particles is accelerated, by performing a heat treatment in silica containing an alkali-earth metal, although the mechanism is not clear. The alkali-earth metal segregates on the inner wall of the silica, and the present inventors consider that the alkali-earth metal has an influence also on a shape of magnetic alloy particles. The alkali-earth metal preferably includes at least any of Ba (barium), Ca (calcium), Sr (strontium) etc. Further, in the state of the magnetic material according to the present invention, the alkali-earth metal compound often exists in a form of an oxide such as BaO, but occasionally exists as a hydroxide or a silicic acid compound.

Moreover, the existence ratio of the alkali-earth metal compound is preferably not less than 0.001 and not more than 0.8, in terms of the ratio of the total molar number of the alkali-earth metal and the total molar number of metals constituting the magnetic alloy particle (alkali-earth metal/magnetic alloy particle). The ratio is more preferably not less than 0.001 and not more than 0.5, and furthermore preferably not less than 0.01 and not more than 0.5.

Next, there will be described a method for manufacturing the magnetic material according to the present invention. The method for manufacturing the magnetic material according to the present invention includes a process of generating a composite metal hydroxide particle in a water phase of a mixed liquid by mixing a raw material micellar solution in which a water phase that contains two or more kinds of metal compounds and is bonded with a surfactant is dispersed in an oil phase, and a neutralizing agent micellar solution in which a water phase that contains a neutralizing agent and is bonded with a surfactant is dispersed in an oil phase; a process of forming a core/shell particle composed of the composite metal hydroxide particle/silica by covering the composite metal hydroxide particle with silica by adding a silicon compound to the mixed liquid; and a process of generating directly a magnetic alloy particle by reducing the composite metal hydroxide particle and ordering a crystal structure by subjecting the core/shell particle composed of composite metal hydroxide particle/silica as a precursor to a calcination heat treatment, in which the raw material micellar solution contains an alkali-earth metal salt in the water phase of the solution.

The above-described method for manufacturing the magnetic material according to the present invention includes the steps of forming a minute composite metal hydroxide containing constituent metals of a magnetic alloy; covering the composite metal hydroxide with a silica carrier by adding a silicon compound; and advancing reduction and ordering simultaneously by heat-treating the composite metal hydroxide.

An outline of the method for manufacturing the magnetic material according to the present invention will be described using FIG. 2. In the present invention, first, there are prepared (FIG. 2(a)) a raw material micellar solution obtained by dispersing a product, in which a surfactant is bonded to an aqueous solution (water phase) of a compound (metal salt or metal complex) of a metal (such as Fe, Co, Pt, or Pd) constituting a magnetic alloy, in an oil phase, and a neutralizing agent micellar solution obtained by dispersing a product, in which a surfactant is bonded to a neutralizing agent aqueous solution (water phase), in an oil phase. Then, a mixed solution of these solutions is manufactured. Hereby, the metal salt reacts with the neutralizing agent in the water phase, and an reverse micelle is generated, which contains fine particles of a composite metal hydroxide constituted by respective metals (FIG. 2(b)).

Next, the composite metal hydroxide fine particle in the reverse micelle state is covered with silica (FIG. 2(c)). In the process, a solution of silicon compound such as silicon alkoxide is added to the mixed solution. Hereby, hydrolysis of the silicon compound is generated in the water phase, and the surface of the composite metal hydroxide fine particle is covered with silica.

The core/shell fine particle composed of composite metal hydroxide fine particle/silica generated in this way acts as a precursor of the magnetic material according to the present invention. The precursor is reduced to form a magnetic alloy as a result of appropriate separation from the mixed solution (FIG. 2(d)) and a heat treatment, and, at this time, the ordering of the crystal structure can be advanced simultaneously (FIG. 2(e)). In the method according to the present invention, performing simultaneously a reduction treatment and ordering on the precursor forms a suitable crystal structure while securing the degree of freedom of respective metal atoms.

More detailed description will be given about respective processes of the method for manufacturing the magnetic material according to the present invention. In the method according to the present invention, the raw material micellar solution and the neutralizing agent micellar solution are manufactured. In the raw material micellar solution, a water phase is an aqueous solution of metal compounds (metal salt, metal complex) of constituent metals of a magnetic alloy. A surfactant is combined to the water phase.

As concrete examples of metal compounds for manufacturing magnetic alloy particles composed of an FePt alloy, a CoPt alloy, an FePd alloy, a Co₃Pt alloy, an Fe₃Pt alloy, a CoPt₃ alloy and an FePt₃ alloy, there are used iron nitrate, iron sulfate, iron chloride, iron acetate, iron ammine complex, iron ethylenediamine complex, iron ethylenediamine tetraacetate, tris(acetylacetonato)iron, iron lactate, iron oxalate, iron citrate, ferrocene, and ferrocene aldehyde etc., as a metal salt or complex of iron. As a metal salt or complex of cobalt, there are used cobalt nitrate, cobalt sulfate, cobalt chloride, cobalt acetate, cobalt ammine complex, cobalt ethylenediamine complex, cobalt ethylenediamine tetraacetate, and cobalt acetylacetonate complex etc. As a metal salt or complex of platinum, there are used chloroplatinic acid, platinum acetate, platinum nitrate, platinum ethylenediamine complex, platinum triphenylphosphine complex, platinum ammine complex and platinum acetylacetonate complex, etc. As metal salt or complex of palladium, there are used palladium acetate, palladium nitrate, palladium sulfate, palladium chloride, palladium triphenylphosphine complex, palladium ammine complex, palladium ethylenediamine complex, and palladium acetylacetonate complex, etc. The composition ratio of constituent metals of a magnetic alloy can be controlled in preparation of the metal salt aqueous solution.

Here, the magnetic material according to the present invention is characterized by containing an alkali-earth metal compound in the silica carrier. The present inventors consider that the alkali-earth metal has such a function as accelerating structure ordering by a calcination heat treatment after forming a precursor to be described later. The alkali-earth metal is added to the raw material micellar solution as an alkali-earth metal compound. Concretely, nitrate, acetate, citrate, carbonate, sulfate, sulfite, chlorate, perchlorate, oxyhalide, salt of organic acid of an alkali-earth metal, etc. are added to the metal salt aqueous solution. The content of the alkali-earth metal in the silica carrier of the magnetic material according to the present invention is adjusted by an addition amount of the alkali-earth metal compound at this time.

Further, a metal salt aqueous solution, an organic solvent to be an oil phase and a surfactant are mixed to prepare the raw material micellar solution. After the addition of the organic solvent and the surfactant to the metal salt aqueous solution, stirring is preferable so that the raw material micellar solution becomes uniform. Here, examples of applicable organic solvents to be an oil phase include alkane (for example, n-heptane, n-hexane, isooctane, octane, nonane, decane, undecane, dodecane etc.), cycloalkane (for example, cyclohexane, cyclopentane, etc.), aromatic hydrocarbons (for example, benzene, toluene, etc.). The used amount of the organic solvent is preferably not less than 1 time and not more than 10 times relative to water in volume ratio.

Examples of applicable surfactants include cationic surfactants such as cetyltrimethylammonium bromide (CTAB), cetyltrimethylammonium chloride (CTAC), potassium oleate, sodium oleate, cethylpyridinum chloride, benzalkonium chloride and cetyldimethylethylammonium bromide; anionic surfactants such as sodium di-2-ethylhexyl sulfosuccinate, sodium cholate, sodium caprylate, sodium stearate and sodium lauryl sulfate; nonionic surfactants such as polyoxyethylene ester, polyoxyethylene ether, polyoxyethylene sorbitan ester, sorbitan ester and polyoxyethylene nonylphenyl ether; amphoteric ion surfactants such as N-alkyl-N,N-dimethylammonio-1-propanesulfonic acid, etc. The used amount of the surfactant is preferably set to not less than 0.01 mol time and not more than 5 mol times relative to water. As a concrete example, the used amount is preferably, in a case of CTAB, not less than 0.01 mole time and not more than 0.05 mole times relative to water, in a case of polyoxyethylene ether, not less than 0.1 mole time and not more than 5 mole times relative to water, and in a case of sodium di-2-ethylhexyl sulfosuccinate, not less than 0.01 mole time and not more than 0.1 mole time relative to water.

On the other hand, the neutralizing agent micellar solution can be produced by mixing an organic solvent to be an oil phase and a surfactant to a neutralizing agent solution. Examples of applicable neutralizing agents include solutions of alkali such as ammonia, sodium hydroxide, potassium hydroxide, tetramethylammonium hydroxide. As to an organic solvent and a surfactant, those used for the raw material micellar solution can be used.

Further, the raw material micellar solution and the neutralizing agent micellar solution prepared as described above are mixed and a hydroxylation reaction of metal salt is generated in the water phase. In the operation, one micellar solution is dropped into another micellar solution, which is stirred for not less than 1 minute and not more than 60 minutes and is made uniform. Hereby, a composite metal hydroxide is generated from respective metal compounds in the water phase.

Subsequently, silica covering is formed by addition of a silicon compound. Concrete examples of applicable silicon compounds to be added to the mixed solution include tetraalkoxysilane (for example, tetraethoxysilane (TEOS), tetramethoxysilane (TMOS)), mercaptoalkyltrialkoxysilane (for example, γ-mercaptopropyltrimethoxysilane (MPS), γ-mercaptopropyltriethoxysilane), aminoalkyltrialkoxysilane (for example, γ-aminopropyltriethoxysilane (APS)), 3-thiocyanatopropyltriethoxysilane, (3-glycidyloxypropyl)triethoxysilane, (3-isocyanatopropyl)triethoxysilane, 3-[2-(2-aminoethylamino)ethylamino]propyltriethoxysilane, etc. The addition amount of the silicon compound is preferably set to not less than 0.5 and not more than 20, in terms of a ratio of a Si molar number and the total molar number of metals in a raw material micelle (Si/raw material micelle). The addition of the silicon compound causes hydrolysis in the water phase of reverse micelle in the mixed solution to generate silica, and preferably the mixed solution is stirred for not less than 1 hour and not more than 48 hours for formation of a sufficient silica membrane.

The silica membrane covers a composite metal hydroxide particle to form a core/shell particle, and preferably the fine particle is separated from the mixed solution and washed for utilizing the fine particle as a precursor of the magnetic material. In the separation operation, centrifugal separation and washing are repeated appropriately and, after that, drying is performed.

A core/shell particle composed of separated composite metal hydroxide particle/silica is heat-treated as a precursor of the magnetic material according to the present invention. The heat treatment is preferably performed in a reducing atmosphere, for example, in a hydrogen atmosphere at not less than 300° C. and not more than 1300° C. Because, at less than 300° C., ordering of a crystal structure of a magnetic alloy particle does not progress. Further, the calcination temperature is preferably set to a temperature as high as possible, but, when the melting temperature of silica is taken into consideration, the upper limit is 1300° C. Retention time at the calcination temperature is preferably not less than 0.5 hours and not more than 10 hours.

As a result of the calcination heat treatment, the magnetic alloy particle covered with the silica carrier is manufactured. In the calcination process, ordering of a crystal structure progresses along with reduction of the composite metal hydroxide particle, and the magnetic alloy particle in the magnetic material after the calcination has suitable magnetic properties.

Then, the magnetic material may be used as a magnetic alloy particle with minute diameter by removing of the silica covering. As a method for removing the silica covering, preferably the magnetic material according to the present invention is etched with an alkaline solution capable of dissolving only silica, such as a sodium hydroxide aqueous solution, a potassium hydroxide ethanol solution or a tetramethylammonium hydroxide aqueous solution. As a suitable etching method, the silica covering can be removed, for example, by an immersion treatment with a sodium hydroxide aqueous solution of 5 M in concentration at 75° C. in temperature for 24 hours. Meanwhile, in the etching process of silica, impurities and the alkali-earth metal compound are also removed in addition to silica and a magnetic alloy particle with high purity is obtained.

### Advantageous Effects of Invention

As described above, the magnetic material according to the present invention contains a magnetic alloy particle suitably ordered and excellent in magnetic properties. The magnetic alloy particle may be manufactured based on the technique, in which a precursor, which is obtained by first generating composite metal hydroxide using an alkaline solution such as an ammonia aqueous solution and forming a silica shell by the addition of TEOS or the like to the composite metal hydroxide, is reduced and ordered simultaneously by a heat treatment in a reducing atmosphere.

### BRIEF DESCRIPTION OF DRAWINGS

FIG. 1 illustrates structures that the magnetic alloy according to the present invention can form (L1₀ structure, DO₁₉ structure, Pmm2 structure, and L1₂ structure).

FIG. 2 illustrates a method for manufacturing a magnetic material according to the present invention.

FIG. 3 illustrates an XRD pattern of a magnetic material in Example 1 of a first embodiment.

FIG. 4 shows a TEM image of the magnetic material in Example 1 of the first embodiment.

FIG. 5 illustrates an XRD pattern of a magnetic material in Example 2 of a second embodiment.

FIG. 6 shows a TEM image of the magnetic material in Example 2 of the second embodiment.

FIG. 7 illustrates an XRD pattern of a magnetic material in Example 3 of a third embodiment,

FIG. 8 shows a TEM image of the magnetic material in Example 3 of the third embodiment,

FIG. 9 illustrates a magnetic hysteresis curve of the magnetic material in Example 3 of the third embodiment.

FIG. 10 illustrates an XRD pattern of a magnetic material in Example 4 of a fourth embodiment.

FIG. 11 shows a TEM image of the magnetic material in Example 4 of the fourth embodiment.

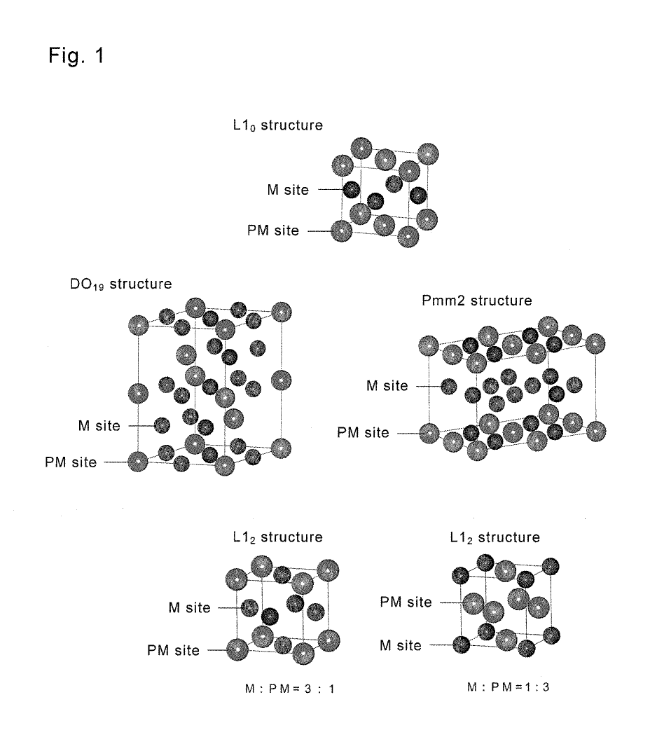

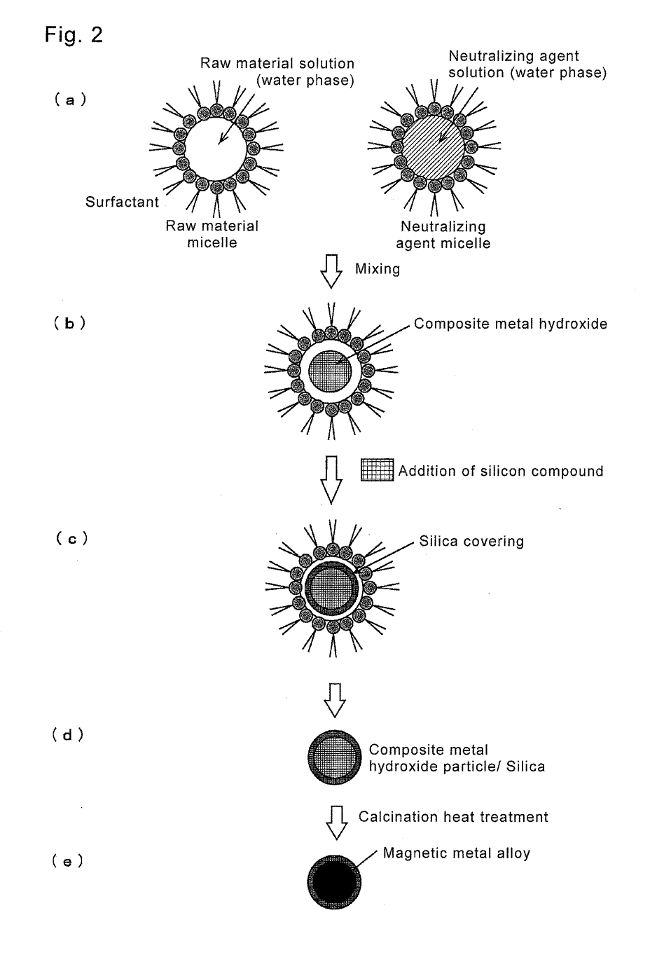

### DESCRIPTION OF EMBODIMENTS

Hereinafter, embodiments of the present invention will be described. In the present embodiments, there was manufactured a magnetic material containing an FePt alloy particle (first embodiment) and a CoPt alloy particle (second embodiment) as magnetic alloy particles, according to the above-described manufacturing process.

### First Embodiment (Formation of FePt Alloy Particle)

(a) Production of Raw Material Micellar Solution

Iron nitrate (Fe(NO₃)₃.9H₂O) and chloroplatinic acid (H₂[PtCl₆].xH₂O) were added to 6 mL of pure water, so as to be 0.12 M in the total of Fe and Pt. Further, 18.82 mg of barium nitrate (Ba(NO₃)₂) (Ba: 0.012 M) was added. A charged amount of barium being an alkali-earth metal is 0.1 in molar ratio relative to the metals (Fe+Pt). 18.3 mL of octane and 3.6 mL of butanol were added to the aqueous solution as organic solvents to be an oil phase, and 3.52 g of CTAB was added as a surfactant. The solution was stirred for 30 minutes until it became uniform, and a raw material micellar solution was produced. Above operations are performed at room temperature. Meanwhile, plural raw material micellar solutions were produced so that the ratio of Fe and Pt (Fe:Pt) became 5:5 (Example 1), 10:0 (Reference Example 1), 9:1 (Reference Example 2), or 0:10 (Reference Example 3). Further, as Comparative Example 1, a raw material micellar solution with no addition of Ba was also produced (Fe:Pt is 5:5).

(b) Production of Neutralizing Agent Micellar Solution

2.26 mL of ammonia (25%-NH₃ aqueous solution) was added to 3.74 mL of pure water as a neutralizing agent. 18.3 mL of octane and 3.6 mL of butanol were added to the solution, and, further, 3.52 g of CTAB was added. The solution was stirred for 30 minutes until it became uniform, and a neutralizing agent micellar solution was produced.

(c) Generation of Composite Metal Hydroxide

The neutralizing agent micellar solution was dropped at 1 drop/sec into the produced raw material micellar solution. The neutralizing agent micellar solution was added with stirring of the mixed solution, and was stirred for additional 30 minutes after completion of the addition.

(d) Silica Covering to Composite Metal Hydroxide

1.5 mL of TEOS was added dropwise at 2 drops/sec into the mixed solution produced as described above. At this time, the addition amount of Si becomes 9.4 in mol ratio relative to the amount of metals (Fe+Pt) in the raw material micellar solution. After completion of the addition, the mixed solution was reacted over 20 hours with stirring. Hereby, silica was deposited onto the surface of a hydroxide particle to cover the particle, and precipitate was generated. Then, the solution was centrifuged (3500 rpm, for 5 minutes) and the solid content was collected, which was washed with mixed liquid of methanol and chloroform and centrifuged, and, further, was washed with methanol and centrifuged. The obtained solid content was dried (air dried and then vacuum dried), and there were obtained core/shell particles of composite hydroxide particle/silica to be a precursor of a magnetic material.

(e) Calcination Heat Treatment (Alloy Generation and Ordering)

The precursor was subjected to a calcination heat treatment in which heating was performed at 980° C. for 4 hours in a hydrogen atmosphere.

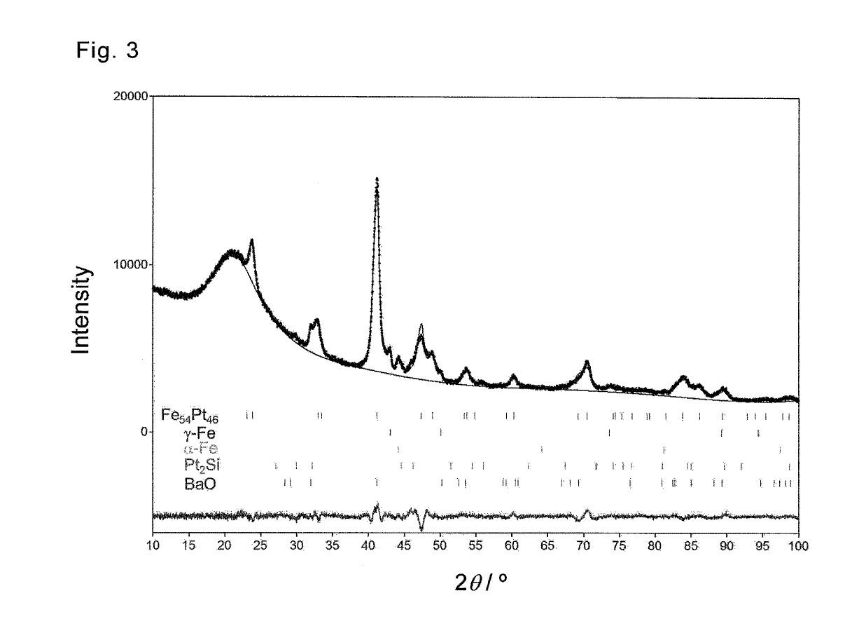

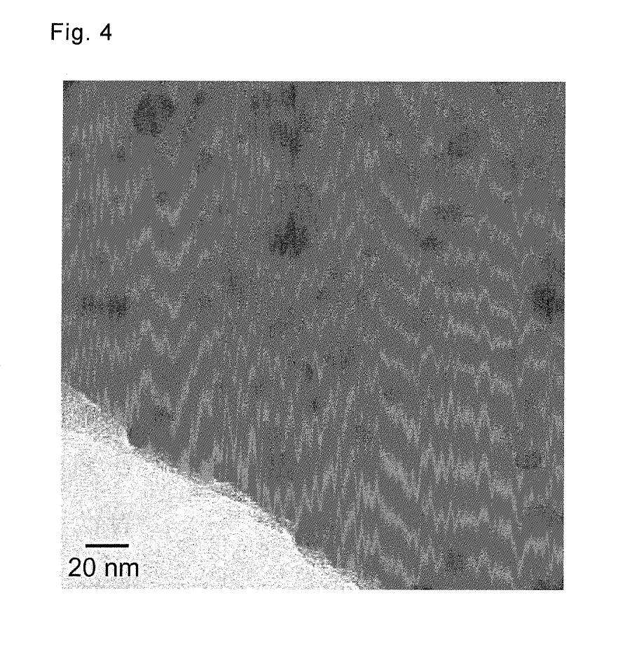

The magnetic material manufactured according to the above process was first subjected to X-ray diffraction (XRD), and a generated phase in the magnetic material was identified. Further, elemental analysis was performed using an inductively-coupled plasma mass spectrometer (ICP-MS) and X-ray fluorescence analysis (XRF). FIG. 3 shows the result of XRD of the magnetic material in Example 1, and FIG. 4 illustrates a TEM image of the magnetic material in Example 1. Further, magnetic properties were evaluated for respective magnetic materials. As to magnetic properties, a magnetic hysteresis curve was measured (temperature 300 K) with a superconducting quantum interference device (SQUID), and coercive force, residual magnetization and saturation magnetization of the magnetic material were measured. The results are shown in Table 1.

TABLE 1

| | | | | | | Magnetic properties*² | | |
|---|---|---|---|---|---|---|---|---|
| | Charged molar | | | | | Coercive | Residual | Saturation |
| | ratio | | | | Generated | force/ | magnetization/ | magnetization/ |
| | Fe | Pt | Ba | Si | phase*¹ | kOe | emug⁻¹ | emug⁻¹ |
| Example 1 | 5 | 5 | 1 | 94 | FePt(fct), | 10 | 4 | 9 |
| | | | | | Pt₂Si, α-Fe, | | | |
| | | | | | γ-Fe, BaO | | | |
| Comparative | 5 | 5 | 0 | 94 | FePt(fct), | 0.2 | 0.9 | 8 |
| example 1 | | | | | α-Fe | | | |
| Reference | 10 | 0 | 1 | 94 | Fe, BaO | 0.2 | 0.7 | 19 |
| example 1 | | | | | | | | |
| Reference | 9 | 1 | 1 | 94 | α-Fe, γ-Fe, | 0.3 | 0.6 | 10 |
| example 2 | | | | | BaO | | | |
| Reference | 0 | 10 | 1 | 94 | Pt₂Si, | —*³ | —*³ | —*³ |
| example 3 | | | | | Pt₁₂Si₅, Pt | | | |

*¹Silica phase (SiO₂) is not described
*²Measured value including silica (SiO₂) being carrier
*³Diamagnetic and unmeasurable

It is known from Table 1 that the magnetic material in Example 1, in which generation/ordering of an alloy was intended with the addition of an alkali-earth metal (Ba), has high coercive force and is favorable also in residual magnetization and saturation magnetization. In Comparative Example 1 with no addition of Ba, saturation magnetization is comparatively high, but coercive force is low. It is considered that, in the Comparative Example, generation of an FePt alloy of an fct structure was estimated in a part from the result of XRD, but that ordering was insufficient.

As the result of elemental analysis for Example 1 using ICP-MS and XRF, it was identified that the composition ratio of the whole including impurities was Fe:Pt=61:39. Further, when the composition ratio was corrected by refining of an XRD pattern in Rietveld refinement and addition of weight ratio of the FePt alloy particle and the impurity, it was calculated that the composition ratio of both metals in the FePt alloy particle was Fe:Pt=54:46. In contrast, the composition ratio of both metals in a sample in Comparative Example 1 was identified as Fe:Pt=75:25 from the result of elemental analysis, and, as the result of correcting this composition ratio by adding a weight ratio of impurities, it was calculated as Fe:Pt=69:31. From this result, consequently, it was confirmed that preferable FePt alloys had the composition ratio of Fe, Pt of nearly 50:50.

Further, in the magnetic material manufactured in Example 1, (Ba/(Fe+Pt)) was 0.10, which was the ratio of the molar number of the alkali-earth metal (Ba) and the total molar number of metals (Fe+Pt) constituting the magnetic alloy particle, obtained from the result of the elemental analysis. Further, (Si/(Fe+Pt)) was 6.1, which was the ratio of the molar number of Si contained in the silica carrier and the total molar number of metals (Fe+Pt) constituting the magnetic alloy particle, in Example 1.

In each of Example 1 and Comparative Example 1, the ratio of Fe, Pt in manufacturing was set to 1:1 (50:50), but the composition ratios of Fe, Pt of formed alloy particles were different. It is considered that the difference is caused by the presence/absence of the addition of the alkali-earth metal in the manufacturing process. However, in Reference Examples 1 to 3, alloy manufacturing is performed at a charge ratio that is predicted to deviate clearly from a suitable composition ratio, and, therefore, sufficient magnetic properties cannot be exerted even if an alkali-earth metal is added.

Next, for the magnetic material in Example 1, the silica carrier was removed and the magnetic alloy particles were collected, and magnetic properties were evaluated. The removal of the silica carrier was performed by an immersion treatment in a sodium hydroxide aqueous solution of 5 M in concentration at 75° C. in temperature for 24 hours. For obtained FePt alloy particles, XRD measurement was performed, purity was analyzed and coercive force was measured with a SQUID magnetometer.

FePt alloy particles having high purity of 98.0% by mass was collected by the silica removal by etching. Magnetic properties of the FePt alloy particle were approximately the same as those before the etching (coercive force: 10 kOe). Accordingly, it was confirmed that useful FePt alloy particles was obtained by the etching treatment.

### Second Embodiment (Formation of CoPt Alloy Particle)

A magnetic material of a CoPt alloy particle with a silica covering was manufactured in the same process as the manufacturing process of the magnetic material of the first embodiment (FePt alloy particle). In the production process of a raw material micellar solution, cobalt nitrate (Co(NO₃)₂.6H₂O) and chloroplatinic acid were added to 6 mL of pure water so as to become 0.12 M in the total of Co and Pt. Barium nitrate was added to the liquid in the same way as in the first embodiment, and, after that, an oil phase (octane+butanol) and a surfactant (CTAB) were added. The addition amount of barium and respective additives are set to the same amount as in the first embodiment. Further, the solution was stirred to produce a raw material micellar solution. Plural solutions were produced so that the ratio of Co and Pt (Co:Pt) in the raw material micellar solution became 5:5 (Example 2), 10:0 (Reference Example 4), 9:1 (Reference Example 5), and 0:10 (Reference Example 6). A raw material micellar solution with no addition of Ba was also produced as Comparative Example 2 (Co:Pt was 5:5).

As a neutralizing agent micellar solution, the same one as in the first embodiment was produced. Then, the neutralizing agent micellar solution was dropped into the raw material micellar solution produced as described above in the same way as in the first embodiment. Further, TEOS was added dropwise into the mixed solution in the same way as in the first embodiment, and was reacted over 20 hours with stirring of the mixed solution. When precipitate was generated in the solution, centrifugation was performed and the solid content was collected, the solid content obtained by repeating washing/centrifugation was dried, and a precursor of the magnetic material was obtained. Finally, the precursor was subjected to a calcination heat treatment, in which heating was performed at 980° C. for 4 hours in a hydrogen atmosphere.

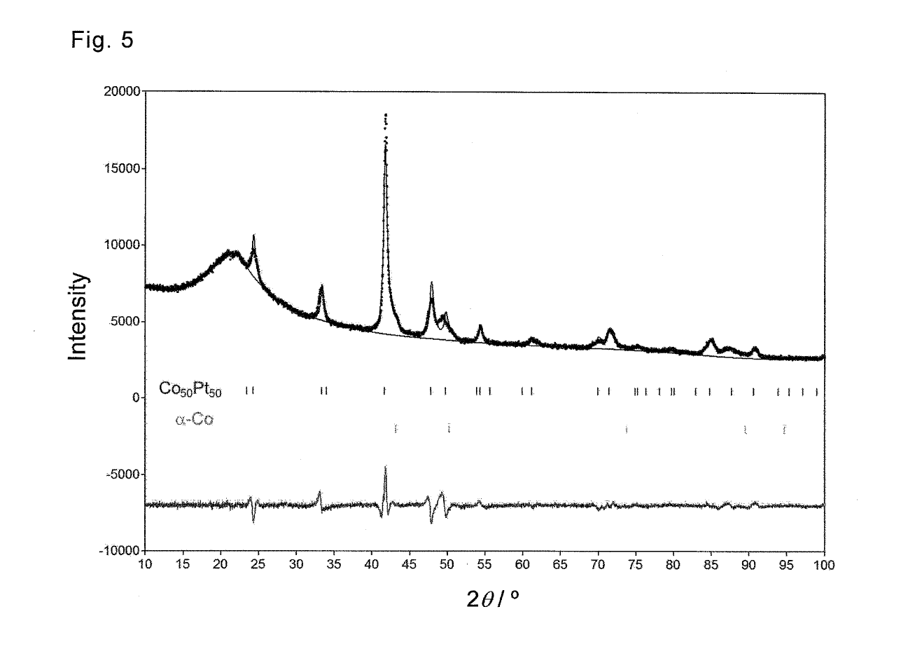

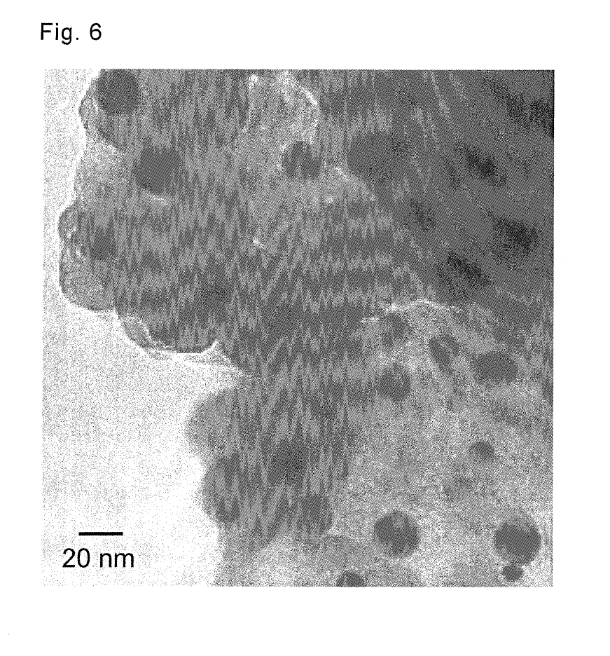

For the magnetic material (CoPt alloy particle covered with silica) manufactured in the present embodiment, too, X-ray diffraction analysis (XRD), elemental analysis (ICP-MS and XRF) and evaluations of magnetic properties were performed. FIGS. 5 and 6 illustrate an XRD result and a TEM image of the magnetic material in Example 2. Further, evaluation results of magnetic properties are shown in Table 2.

TABLE 2

| | | | | | | Magnetic properties*² | | |
|---|---|---|---|---|---|---|---|---|
| | Charged molar | | | | | Coercive | Residual | Saturation |
| | ratio | | | | Generated | force/ | magnetization/ | magnetization/ |
| | Co | Pt | Ba | Si | phase*¹ | kOe | emug⁻¹ | emug⁻¹ |
| Example 2 | 5 | 5 | 1 | 94 | CoPt(fct), | 1.1 | 3 | 7 |
| | | | | | α-Co | | | |
| Comparative | 5 | 5 | 0 | 94 | CoPt(fct), | 0.4 | 1 | 7 |
| example 2 | | | | | α-Co | | | |
| Reference | 10 | 0 | 1 | 94 | α-Co | 0.2 | 2 | 11 |
| example 4 | | | | | | | | |
| Reference | 9 | 1 | 1 | 94 | Co₃Pt(fct), | 0.2 | 2 | 11 |
| example 5 | | | | | α-Co | | | |
| Reference | 0 | 10 | 1 | 94 | PtSi, Pt₂Si, | —*³ | —*³ | —*³ |
| example 6 | | | | | Pt₃Si, Pt | | | |

*¹Silica phase (SiO₂) is not described
*²Measured value including silica (SiO₂) being carrier
*³Diamagnetic and unmeasurable

It is known from Table 2, also for the embodiment (CoPt alloy particle), that the magnetic material (Example 2), for which it was intended to perform generation/ordering of the alloy with addition of the alkali-earth metal, has excellent coercive force and good residual magnetization and saturation magnetization as compared with Comparative Example 2 with no addition of Ba.

Further, a composition ratio of both metals in the CoPt alloy particle in Example 2 was calculated similar to the first embodiment, and Co:Pt=58:42 was identified from elemental analysis by ICP-MS and XRF. Further, when the composition ratio was corrected by refining of an XRD pattern in Rietveld refinement and addition of weight ratio of the CoPt alloy particle and the impurity, it was calculated that the composition ratio of both metals in the CoPt alloy particle was Co:Pt=50:50. In the same way, the composition ratio of the CoPt alloy particle in Comparative Example 2 was identified as Co:Pt=60:40 from elemental analysis, and, as the result of correction with addition of a weight ratio of impurities, it was calculated as Co:Pt=30:70.

Further, (Ba/(Co+Pt)) was 0.021, which was the ratio of the molar number of the alkali-earth metal (Ba) and the total molar number of metals (Co+Pt) constituting the magnetic alloy particle in the magnetic material manufactured in Example 2. Furthermore, (Si/(Co+Pt)) was 5.9, which was the ratio of the molar number of Si contained in the silica carrier and the total molar number of metals (Co+Pt) constituting the magnetic alloy particle in Example 2.

### Third Embodiment (Formation of FePt Alloy Particle)

In the embodiment, an FePt alloy particle (Example 3) was manufactured based on the FePt alloy particle in the first embodiment, while increasing the used amount of raw materials etc. 4 times.

(a) Production of Raw Material Micellar Solution

Iron nitrate (Fe(NO₃)₃.9H₂O) and chloroplatinic acid (H₂[PtCl₆].xH₂O) were added to 24 mL of pure water so that the total of Fe and Pt became 0.12 M. Further, 75.32 mg of barium nitrate (Ba(NO₃)₂) (Ba: 0.012 M) was added. The charged amount of barium being an alkali-earth metal becomes 0.1 relative to metals (Fe, Pt) in terms of a molar ratio ([A]/[M+PM]). 73.2 mL of octane and 14.4 mL of butanol were added to the aqueous solution as organic solvents to be an oil phase, and 14.08 g of CTAB was added as a surfactant. The solution was stirred for 90 minutes until it became uniform, and a raw material micellar solution was produced. Above operations are performed at room temperature. In the raw material micellar solution, the ratio of Fe and Pt (Fe:Pt) is 5:5, similar to Example 1.

(b) Production of Neutralizing Agent Micellar Solution

9.04 mL of ammonia (25%-NH₃ aqueous solution) was added to 14.96 mL of pure water as a neutralizing agent. 73.2 mL of octane and 14.4 mL of butanol were added to the solution, and, further, 14.08 g of CTAB was added. The solution was stirred for 90 minutes until it became uniform, to produce a neutralizing agent micellar solution.

(c) Generation of Composite Metal Hydroxide

The neutralizing agent micellar solution was dropped into the produced raw material micellar solution at 1 drop/sec. The mixed solution was stirred when the neutralizing agent micellar solution was added, and was stirred for additional 30 minutes after completion of the addition.

(d) Silica Covering to Composite Metal Hydroxide

6.0 mL of TEOS was added dropwise at 2 drops/sec to the mixed solution produced as described above. At this time, the addition amount of Si ([Si]) becomes 9.4 in molar ratio relative to molar numbers of metals (Fe, Pt) ([M+PM]) in the raw material micellar solution. After completion of the addition, a reaction was performed over 20 hours with stirring of the mixed solution. Hereby, silica was deposited onto the surface of a hydroxide particle to cover the particle, and precipitate was generated. Then, the solution was centrifuged (3500 rpm, for 5 minutes) and the solid content was collected, which was washed with mixed liquid of methanol and chloroform and centrifuged, and, further, was washed with methanol and centrifuged. The obtained solid content was dried (air dried and then vacuum dried), and there were obtained core/shell particles of composite hydroxide particle/silica to be a precursor of a magnetic material.

(e) Calcination Heat Treatment (Generation and Ordering of Alloy)

The precursor was subjected to a calcination heat treatment in which heating was performed at 980° C. for 4 hours in a hydrogen atmosphere.

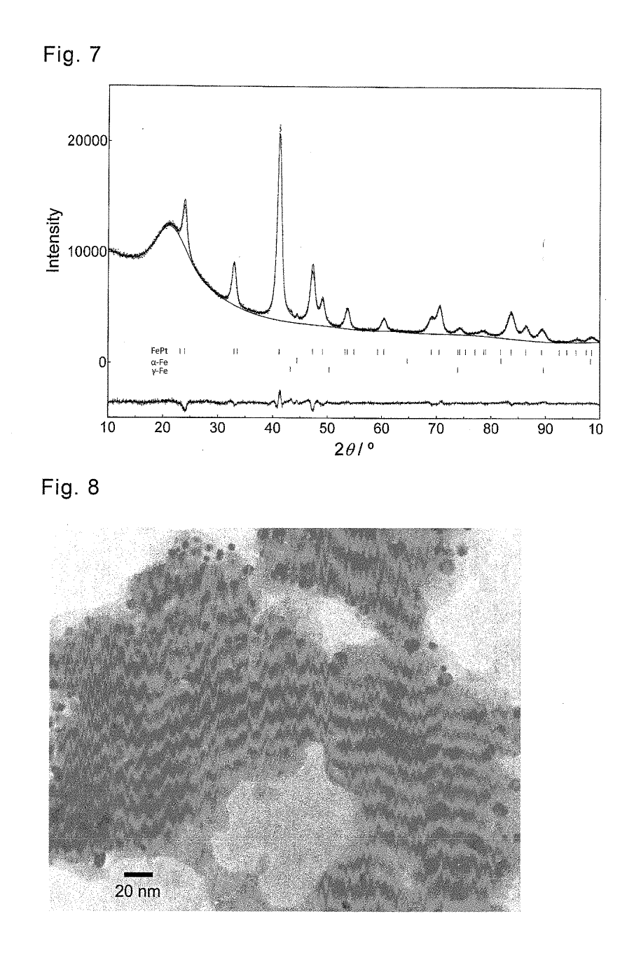

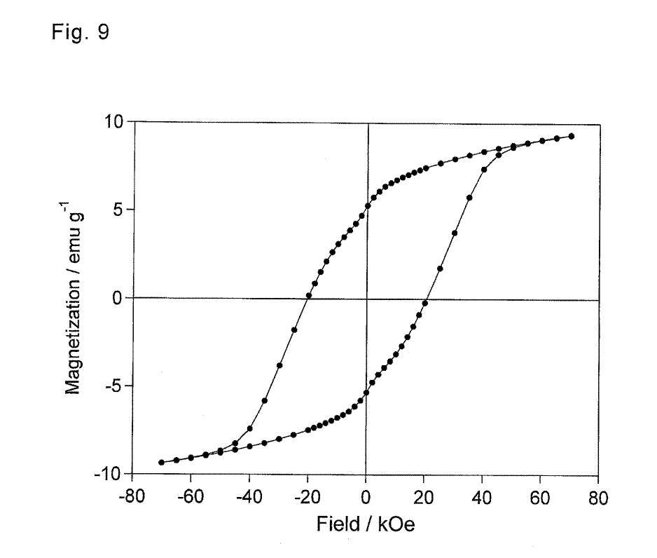

The magnetic material in Example 3 manufactured in the above-described processes was subjected to X-ray diffraction analysis (XRD), and a generated phase in the magnetic material was identified. Further, elemental analysis using X-ray fluorescence analysis (XRF) was performed. FIG. 7 shows the result of XRD of the magnetic material in Example 3. FIG. 8 shows a TEM image of the magnetic material. Further, magnetic properties were evaluated for the magnetic material. As to magnetic properties, a magnetic hysteresis curve was measured (temperature 300 K) with a superconducting quantum interference device (SQUID), and coercive force, residual magnetization and saturation magnetization of the magnetic material were measured. The results are shown in Table 3. In Table 3, both results of Example 1 and Comparative Example 1 in the first embodiment are shown together. Moreover, FIG. 9 illustrates a magnetic hysteresis curve measured for the magnetic material in Example 3.

TABLE 3

| | | | | | | Magnetic properties*² | | |
|---|---|---|---|---|---|---|---|---|
| | Charged molar | | | | | Coercive | Residual | Saturation |
| | ratio | | | | Generated | force/ | magnetization/ | magnetization/ |
| | Fe | Pt | Ba | Si | phase*¹ | kOe | emug⁻¹ | emug⁻¹ |
| Example 3 | 5 | 5 | 1 | 94 | FePt(fct), | 21 | 5 | 9 |
| | | | | | α-Fe, γ-Fe | | | |
| Example 1 | 5 | 5 | 1 | 94 | FePt(fct), | 10 | 4 | 9 |
| | | | | | Pt₂Si, α-Fe, | | | |
| | | | | | γ-Fe, BaO | | | |
| Comparative | 5 | 5 | 0 | 94 | FePt(fct), | 0.2 | 0.9 | 8 |
| example 1 | | | | | α-Fe | | | |

*¹Silica phase (SiO₂) is not described
*²Measured value including silica (SiO₂) being carrier

From Table 3, the magnetic material in Example 3 had very good coercive force, residual magnetization and saturation magnetization. It has good magnetic properties when compared with the magnetic material in Example 1. Meanwhile, it was identified as Fe:Pt=60:40 in the magnetic material in Example 3 from the result of elemental analysis. Then, when the composition ratio was corrected by refining of an XRD pattern in Rietveld refinement and addition of weight ratio of the FePt alloy particle and the impurity, it was calculated that the composition ratio of both metals in the FePt alloy particle was Fe:Pt=53:47. Further, a molar ratio ([Ba]/[Fe+Pt]) of the content of the alkali-earth metal ([Ba]) and the content of metals [Fe+Pt] constituting the magnetic alloy particle was 0.02.

### Fourth Embodiment (Formation of FePt Alloy Particle)

In the embodiment, an FePt alloy particle (Example 4) was manufactured based on the FePt alloy particle in the first embodiment, while applying calcium as an alkali-earth metal to be added in a process of producing a raw material micellar solution.

(a) Production of Raw Material Micellar Solution

Iron nitrate (Fe(NO₃)₃.9H₂O) and chloroplatinic acid (H₂[PtCl₆].xH₂O) were added to 24 mL of pure water so that the total of Fe and Pt became 0.12 M. Further, 68.01 mg of calcium nitrate (Ca(NO₃)₂.4H₂O) (Ca:0.012 M) was added. The charged amount of calcium being an alkali-earth metal becomes 0.1 relative to metals (Fe, Pt) in terms of a molar ratio ([A]/[M+PM]). 73.2 mL of octane and 14.4 mL of butanol were added to the aqueous solution as organic solvents to be an oil phase, and 14.08 g of CTAB was added as a surfactant. The solution was stirred for 90 minutes until it became uniform, and a raw material micellar solution was produced. Above operations are performed at room temperature. In the raw material micellar solution, the ratio of Fe and Pt (Fe:Pt) is 5:5, similar to Example 1.

(b) Production of Neutralizing Agent Micellar Solution

9.04 mL of ammonia (25%-NH₃ aqueous solution) was added to 14.96 mL of pure water as a neutralizing agent. 73.2 mL of octane and 14.4 mL of butanol were added to the solution, and, further, 14.08 g of CTAB was added. The solution was stirred for 90 minutes until it became uniform, and a neutralizing agent micellar solution was produced,

(c) Generation of Composite Metal Hydroxide

The neutralizing agent micellar solution was dropped into the produced raw material micellar solution at 1 drop/sec. The mixed solution was stirred when the neutralizing agent micellar solution was added, and was stirred for additional 30 minutes after completion of the addition.

(d) Silica Covering to Composite Metal Hydroxide

6.0 mL of TEOS was added dropwise at 2 drops/sec to the mixed solution produced as described above. At this time, the addition amount of Si ([Si]) becomes 9.4 in molar ratio relative to molar numbers of metals (Fe, Pt) ([M+PM]) in the raw material micellar solution. After completion of the addition, a reaction was performed over 20 hours with stirring of the mixed solution. Hereby, silica was deposited onto the surface of a hydroxide particle to cover the particle, and precipitate was generated. Then, the solution was centrifuged (3500 rpm, for 5 minutes) and the solid content was collected, which was washed with mixed liquid of methanol and chloroform and centrifuged, and, further, was washed with methanol and centrifuged. The obtained solid content was dried (air dried and then vacuum dried), and there were obtained core/shell particles of composite hydroxide particle/silica to be a precursor of a magnetic material.

(e) Calcination heat treatment (generation and ordering of alloy)

The precursor was subjected to a calcination heat treatment in which heating was performed at 980° C. for 4 hours in a hydrogen atmosphere.

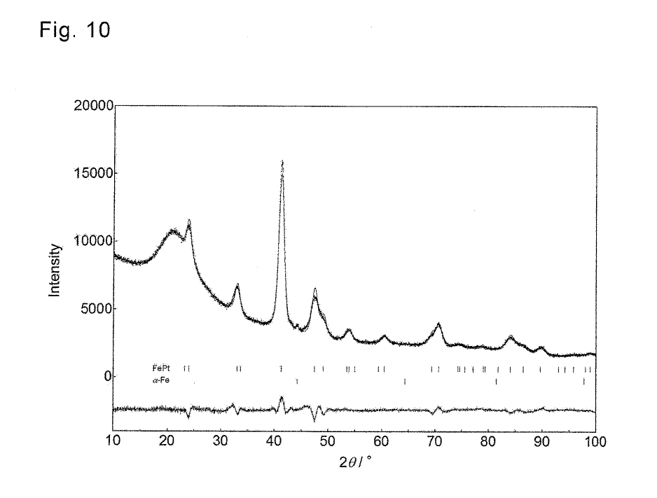

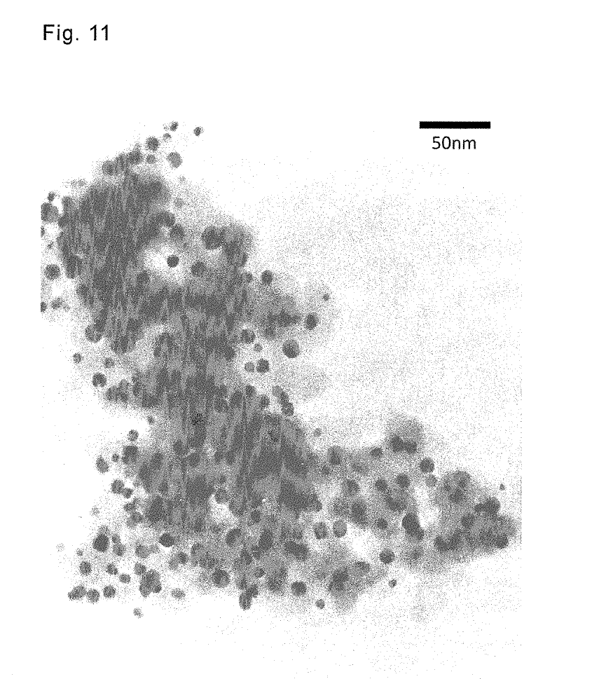

The magnetic material in Example 4 manufactured in the above-described processes was subjected to X-ray diffraction analysis (XRD), and a generated phase in the magnetic material was identified. Further, elemental analysis using X-ray fluorescence analysis (XRF) was performed. FIG. 10 shows the result of XRD of the magnetic material in Example 4. FIG. 11 shows a TEM image of the magnetic material. Further, magnetic properties were evaluated for the magnetic material. As to magnetic properties, a magnetic hysteresis curve was measured (temperature 300 K) with a superconducting quantum interference device (SQUID), and coercive force, residual magnetization and saturation magnetization of the magnetic material were measured. The results are shown in Table 4. In Table 4, both results of Example 1 and Comparative Example 1 in the first embodiment are described together.

TABLE 4

| | Charged molar | | | | | | | |
|---|---|---|---|---|---|---|---|---|
| | ratio | | | | | Magnetic properties*² | | |
| | | | Alkali- | | | Coercive | Residual | Saturation |
| | | | earth | | Generated | force/ | magnetization/ | magnetization/ |
| | Fe | Pt | metal | Si | phase*¹ | kOe | emug⁻¹ | emug⁻¹ |
| Example 4 | 5 | 5 | 1 | 94 | FePt(fct), | 11 | 5 | 8 |
| | | | (Ca) | | α-Fe | | | |
| Example 1 | 5 | 5 | 1 | 94 | FePt(fct), | 10 | 4 | 9 |
| | | | (Ba) | | Pt₂Si, α-Fe, | | | |
| | | | | | γ-Fe, BaO | | | |
| Comparative | 5 | 5 | 0 | 94 | FePt(fct), | 0.2 | 0.9 | 8 |
| example 1 | | | | | α-Fe | | | |

*¹Silica phase (SiO₂) is not described
*²Measured value including silica (SiO₂) being carrier

From Table 4, the magnetic material in Example 4 had very good coercive force, residual magnetization and saturation magnetization. It has good magnetic properties when compared with the magnetic material in Example 1. From the result of the present embodiment, it was confirmed that calcium was also effective as an alkali-earth metal to be applied in a production process of the raw material micellar solution. Meanwhile, it was identified as Fe:Pt=60:40 in the magnetic material in Example 4 from the result of elemental analysis. Then, when the composition ratio was corrected by refining of an XRD pattern in Rietveld refinement and addition of weight ratio of the FePt alloy particle and the impurity, it was calculated that the composition ratio of both metals in the FePt alloy particle was Fe:Pt=59:41. Further, a molar ratio ([Ca]/[Fe+Pt]) of the content of the alkali-earth metal ([Ca]) and the content of metals [Fe+Pt] constituting the magnetic alloy particle was 0.11.

### INDUSTRIAL APPLICABILITY

The magnetic material according to the present invention holds a magnetic alloy particle having crystal magnetic anisotropy, has an effectively ordered crystal structure regarding the magnetic alloy particle, and has suitable magnetic properties. Developments of magnetic recording media with more enhanced recording density as compared with conventional one can be expected by suitable picking out and utilization of the magnetic alloy particle.

1. A magnetic material comprising a magnetic alloy particle having crystal magnetic anisotropy and a silica carrier covering the magnetic alloy particle, wherein
the silica carrier contains an alkali-earth metal compound.

2. The magnetic material according to claim 1, wherein the alkali-earth metal compound comprises at least any of oxide, hydroxide and silicic acid compounds of Ba, Ca, and Sr.

3. The magnetic material according to claim 1, wherein a ratio of a total molar number of alkali-earth metals and a total molar number of metals constituting the magnetic alloy particle (alkali-earth metal/magnetic alloy particle) is not less than 0.001 and not more than 0.8.

4. The magnetic material according to claim 1, wherein the magnetic alloy particle comprises any of an FePt alloy, a CoPt alloy, an FePd alloy, a Co₃Pt alloy, an Fe₃Pt alloy, a CoPt₃ alloy, and an FePt₃ alloy.

5. The magnetic material according to claim 1, wherein the magnetic alloy particle has a particle diameter of not less than 1 nm and not more than 100 nm.

6. A method for manufacturing a magnetic material, the magnetic material being defined in claim 1, comprising the steps of: generating a composite metal hydroxide particle in a water phase of a mixed liquid by mixing a raw material micellar solution in which a water phase that contains two or more kinds of metal compounds and is bonded with a surfactant is dispersed in an oil phase, and a neutralizing agent micellar solution in which a water phase that contains a neutralizing agent and is bonded with a surfactant is dispersed in an oil phase;
forming a core/shell particle composed of the composite metal hydroxide particle/silica by covering the composite metal hydroxide particle with silica by adding a silicon compound to the mixed liquid; and
generating directly a magnetic alloy particle by reducing the composite metal hydroxide particle and ordering a crystal structure by subjecting the core/shell particle composed of composite metal hydroxide particle/silica as a precursor to a calcination heat treatment, wherein
the raw material micellar solution contains an alkali-earth metal salt in the water phase of the solution.

7. The method for manufacturing a magnetic material according to claim 6, wherein the metal compounds in the raw material micellar solution are two or more kinds of metal compounds for forming an FePt alloy, a CoPt alloy, an FePd alloy, a Co₃Pt alloy, an Fe₃Pt alloy, a CoPt₃ alloy or an FePt₃ alloy, and the metal compounds are two or more kinds of metal compounds selected from iron nitrate, iron sulfate, iron chloride, iron acetate, iron ammine complex, iron ethylenediamine complex, iron ethylenediamine tetraacetate, tris(acetylacetonato)iron, iron lactate, iron oxalate, iron citrate, ferrocene and ferrocene aldehyde, cobalt nitrate, cobalt sulfate, cobalt chloride, cobalt acetate, cobalt ammine complex, cobalt ethylenediamine complex, cobalt ethylenediamine tetraacetate, cobalt acetylacetonate complex, chloroplatinic acid, platinum acetate, platinum nitrate, platinum ethylenediamine complex, platinum triphenylphosphine complex, platinum ammine complex and platinum acetylacetonate complex, palladium acetate, palladium nitrate, palladium sulfate, palladium chloride, palladium triphenylphosphine complex, palladium ammine complex, palladium ethylenediamine complex and palladium acetylacetonate complex.

8. The method for manufacturing a magnetic material according to claim 6, wherein the neutralizing agent in the neutralizing agent micellar solution is at least any of ammonia, sodium hydroxide, potassium hydroxide and tetramethylammonium hydroxide.

9. The method for manufacturing a magnetic material according to claim 6, wherein the surfactant in the raw material micellar solution and the neutralizing agent micellar solution is at least any of cetyltrimethylammonium bromide, cetyltrimethylammonium chloride, potassium oleate, sodium oleate, cetylpyridinum chloride, benzalkonium chloride, cetyldimethylethylammonium bromide, sodium di-2-ethylhexyl sulfosuccinate, sodium cholate, sodium caprylate, sodium stearate, sodium lauryl sulfate, polyoxyethylene ester, polyoxyethylene ether, polyoxyethylene sorbitan ester, sorbitan ester, polyoxyethylene nonylphenyl ether and N-alkyl-N,N-dimethylammonio-1-propanesulfonic acid.

10. The method for manufacturing a magnetic material according to claim 6, wherein the silicon compound is at least any of tetraalkoxysilane, mercaptoalkyltrialkoxysilane, aminoalkyltrialkoxysilane, 3-thiocyanatopropyltriethoxysilane, 3-glycidyloxypropyltriethoxysilane, 3-isocyanatopropyltriethoxysilane and 3-[2-(2-aminoethylamino)ethylamino]propyltriethoxysilane.

11. The method for manufacturing a magnetic material according to claim 6, wherein the calcination heat treatment of the core/shell particle composed of composite metal hydroxide particle/silica is a heat treatment performed at not less than 300° C. and not more than 1300° C. in a reducing atmosphere.

12. A method for manufacturing a magnetic alloy particle having crystal magnetic anisotropy, wherein
the method removes a silica covering by etching, with an alkaline solution, a magnetic material manufactured by a method being defined in any of claims 6 to 11.

13. The method for manufacturing a magnetic alloy particle according to claim 12, wherein the alkaline solution is at least any of a sodium hydroxide aqueous solution, a tetramethylammonium hydroxide aqueous solution and a potassium hydroxide ethanol solution.

14. The magnetic material according to claim 2, wherein a ratio of a total molar number of alkali-earth metals and a total molar number of metals constituting the magnetic alloy particle (alkali-earth metal/magnetic alloy particle) is not less than 0.001 and not more than 0.8.

15. The magnetic material according to claim 2, wherein the magnetic alloy particle comprises any of an FePt alloy, a CoPt alloy, an FePd alloy, a Co₃Pt alloy, an Fe₃Pt alloy, a CoPt₃ alloy, and an FePt₃ alloy.

16. The magnetic material according to claim 2, wherein the magnetic alloy particle has a particle diameter of not less than 1 nm and not more than 100 nm.

17. A method for manufacturing a magnetic material, the magnetic material being defined in claim 2, comprising the steps of: generating a composite metal hydroxide particle in a water phase of a mixed liquid by mixing a raw material micellar solution in which a water phase that contains two or more kinds of metal compounds and is bonded with a surfactant is dispersed in an oil phase, and a neutralizing agent micellar solution in which a water phase that contains a neutralizing agent and is bonded with a surfactant is dispersed in an oil phase;
forming a core/shell particle composed of the composite metal hydroxide particle/silica by covering the composite metal hydroxide particle with silica by adding a silicon compound to the mixed liquid; and
generating directly a magnetic alloy particle by reducing the composite metal hydroxide particle and ordering a crystal structure by subjecting the core/shell particle composed of composite metal hydroxide particle/silica as a precursor to a calcination heat treatment, wherein
the raw material micellar solution contains an alkali-earth metal salt in the water phase of the solution.

18. The method for manufacturing a magnetic material according to claim 17, wherein the metal compounds in the raw material micellar solution are two or more kinds of metal compounds for forming an FePt alloy, a CoPt alloy, an FePd alloy, a Co₃Pt alloy, an Fe₃Pt alloy, a CoPt₃ alloy or an FePt₃ alloy, and the metal compounds are two or more kinds of metal compounds selected from iron nitrate, iron sulfate, iron chloride, iron acetate, iron ammine complex, iron ethylenediamine complex, iron ethylenediamine tetraacetate, tris(acetylacetonato)iron, iron lactate, iron oxalate, iron citrate, ferrocene and ferrocene aldehyde, cobalt nitrate, cobalt sulfate, cobalt chloride, cobalt acetate, cobalt ammine complex, cobalt ethylenediamine complex, cobalt ethylenediamine tetraacetate, cobalt acetylacetonate complex, chloroplatinic acid, platinum acetate, platinum nitrate, platinum ethylenediamine complex, platinum triphenylphosphine complex, platinum ammine complex and platinum acetylacetonate complex, palladium acetate, palladium nitrate, palladium sulfate, palladium chloride, palladium triphenylphosphine complex, palladium ammine complex, palladium ethylenediamine complex and palladium acetylacetonate complex.

19. The method for manufacturing a magnetic material according to claim 18, wherein the neutralizing agent in the neutralizing agent micellar solution is at least any of ammonia, sodium hydroxide, potassium hydroxide and tetramethylammonium hydroxide.

20. The method for manufacturing a magnetic material according claim 19, wherein the surfactant in the raw material micellar solution and the neutralizing agent micellar solution is at least any of cetyltrimethylammonium bromide, cetyltrimethylammonium chloride, potassium oleate, sodium oleate, cetylpyridinum chloride, benzalkonium chloride, cetyldimethylethylammonium bromide, sodium di-2-ethylhexyl sulfosuccinate, sodium cholate, sodium caprylate, sodium stearate, sodium lauryl sulfate, polyoxyethylene ester, polyoxyethylene ether, polyoxyethylene sorbitan ester, sorbitan ester, polyoxyethylene nonylphenyl ether and N-alkyl-N,N-dimethylammonio-1-propanesulfonic acid.
